(19) United States
(12) Patent Application Publication
(10) Pub. No.: US 2025/0141284 A1
(43) Pub. Date: May 1, 2025

(54) PRIME SOURCE FOR POWER GENERATION

(71) Applicant: V2Techs Inc., Melbourne, FL (US)

(72) Inventor: Vladimir Corneliu Vlad, Melbourne Beach, FL (US)

(73) Assignee: V2Techs Inc., Melbourne, FL (US)

(21) Appl. No.: 18/689,414

(22) PCT Filed: Sep. 13, 2022
(86) PCT No.: PCT/US2022/076339

§ 371 Date: Mar. 5, 2024

Related U.S. Application Data
(60) Provisional application No. 63/247,010, filed on Sep. 22, 2021.

(51) Int. Cl. H02K 1/27; B63B 35/44; B63H 21/17; B63H 21/21; H02K 7/00; H02K 11/00; H02P 23/14

(52) U.S. Cl. CPC H02K 1/27; B63H 21/17; B63H 21/21; H02K 7/003; H02K 11/0094; H02P 23/14; B63B 2035/4466

(57) ABSTRACT

An apparatus for rotating a shaft, the apparatus includes an inner ring, an outer ring, a plurality of electromagnets positioned between the inner ring and the outer ring, a plurality of planar collector coils positioned around the inner ring, a battery electrically connected to the plurality of electromagnets and the plurality of planar collector coils, and a control system operatively connected to the battery and the plurality of electromagnets. The apparatus may further include a human machine interface in operative communication with the control system wherein the human machine interface is configured to receive as input from an operator a revolutions per minute for operation of the power generator. The apparatus may be a part of a vehicle such as a ship or other electric vehicle.

### PRIORITY

This application claims priority to U.S. Provisional Patent Application No. 63/247,010 filed Sep. 22, 2021, respectively, which is hereby incorporated by reference in its entirety.

### FIELD OF THE INVENTION

The present invention relates to providing a prime source for power generation. More particularly, but not exclusively, the present invention relates to improving efficiency of power generation.

### BACKGROUND OF ART

Electric power generators generally provide for transforming mechanical force into electrical current through electromagnetic induction. In electrical power generation various methods are used to create the mechanical force often used to rotate a shaft and thus serve as the prime source. Various methods include, for example, wind, water, steam, and combustion engines.

One example of problems in the art relate to the shipping industry. Shipping is considered to be responsible for 18-30 percent of the world's nitrogen oxide (NOx) pollution and 9 percent of the global sulfur oxide (Sox) pollution. With 90 percent of all international trade transported by ships, this is a significant problem. It is also noted that 70 percent of all ship emissions are withing 400 km of land. A single large cargo ship emits the CO₂ equivalent of 70,000 cars. In addition, where ships include fossil fuel storage this detracts from the ship's cargo capacity. One approach to addressing this pollution problem has been to use electric ships. There are currently a growing number of electric ships with a current estimate of over 2000 electric ships worldwide. Yet problems remain with electric ships.

One of the problems with electric ships is the need for charging stations. To fully accommodate widespread use of electric ships would require a significant global infrastructure change or else limit the travel paths of ships. Other problems relate to large scale lithium energy storage and concerns about safety and reliability. It would be advantageous if electric power could be generated on-board and on-demand so that less energy storage was required and charging stations were not required.

A further problem with electric ships is providing sufficient electric power to allow for larger ships, faster ships, and/or longer journeys. It would be advantageous if electric power could be generated on board and on-demand so larger ships could be powered, ships with greater power requirements could be made electric, and electric ships could have longer journeys and not be restricted to shorter shipping routes with charging stations along the way.

Although the significance may not be apparent without having the benefit of this disclosure, NL2017352, hereby incorporated by reference, describes a method and apparatus for operating a brushless motor which may be used to drive a power generator. Although conceptually innovative and revolutionary, the system disclosed has a number of limitations especially for use in industry or commercial environments. For example, NL2017352 describes the use of one or more electromagnetic telescopic arms which require precise adjustment. Making such precise adjustment may require skills not every operator may have which may result in adjustments which do not permit optimized operation. In addition, making precise adjustments may take time thus increasing the amount of time that the system is down for maintenance (such as to replace the rechargeable battery). Where multiple arms are used, the problem is compounded. In some environments, including when used on an electric ship, minimization of downtime is a primary concern. Another limitation is that where collector coils are positioned on the arms, there may be an insufficient number to maintain the charge of the battery at a desired level or for a desired amount of time. Another limitation is that the size of battery used in the electromagnetic telescopic arm of NL2017352 may not be sufficient to store enough charge to overcome the starting torque required in an industrial installation. In addition, the system is not constructed in a manner which is conducive to an industrial or commercial environment such as on a ship which may have harsh operating conditions and additional challenges regarding maintenance such as enclosed spaces, limited maintenance personnel, and otherwise limited access to resources when at sea. A related concern is safety in that NL2017352 does not, for example, have protective housing or casing to protect the entire unit and its operators. In addition, a further problem is the need for close monitoring and control of the system or multiple systems. Therefore, problems remain.

What is needed are methods, apparatuses, and systems for increasing the efficiency of power generation.

### SUMMARY

Therefore, it is a primary object, feature, or advantage to improve over the state of the art.

It is a further object, feature, or advantage to provide a method, apparatus, and system which can act as a prime mover for different sizes of electric power generators.

It is a still further object, feature, or advantage to provide a method, apparatus, and system

It is a still further object, feature, or advantage to provide an apparatus which may act as a substitute to hydro, wind, fossil, and nuclear energy to provide a rotational energy sources.

Another object, feature, or advantage is to provide methods, apparatus, and systems which may be used with commercially available electric power generators.

Yet another object, feature, or advantage is to provide methods, apparatus, and systems which allow for easy access to and maintenance of equipment.

Another object, feature, or advantage it to provides methods, apparatus, and systems which are safe.

Yet another object, feature, or advantage it to provides methods, apparatus, and systems which are safe which require little maintenance.

A further object, feature, or advantage is to provide methods, apparatus, and systems which may be used in industrial and commercial environments.

Another object, feature, or advantage is to provide methods, apparatus, and systems for energy production which can be operated safely via remote control.

Yet another object, feature, or advantage is to provide methods, apparatus, and systems for energy production which do not require charging stations.

According to one aspect, an apparatus for rotating a shaft is provided. The apparatus may include an outer ring, a plurality of electromagnets positioned between the inner ring and the outer ring, a plurality of planar collector coils positioned around the inner ring, a battery electrically connected to the plurality of electromagnets and the plurality of planar collector coils, and a control system operatively connected to the battery and the plurality of electromagnets. The apparatus may further include a disc secured to the inner ring. The apparatus may further include a human machine interface in operative communication with the control system wherein the human machine interface is configured to receive as input from an operator a revolutions per minute for operation of the power generator. The human machine interface may be further configured to receive as input from an operator a torque value for the power generator. The apparatus may further include a housing comprising a first assembly, a second assembly, and third assembly and wherein the first assembly is hinged to the second assembly, and the third assembly is hinged to the second assembly. The first assembly may include a door with a window. The second assembly may include the inner ring, the outer ring, the plurality of electromagnets, and the plurality of planar connector coils. The third assembly may include the battery and a computer associated with the control system. The apparatus may further include a human machine interface in operative communication with the control system. A vehicle may include the apparatus with the shaft configured to assist in generating movement for the vehicle. The vehicle may be a ship.

According to another aspect a system is configured for managing rotation of a shaft associated with a power generator. The system includes a stator assembly, the stator assembly includes an inner ring, an outer ring, a plurality of electromagnets positioned between the inner ring and the outer ring, and a plurality of planar collector coils positioned on a face of the inner ring. The rotor assembly may include a disc, a rotor ring secured to the disc, and a plurality of permanent magnets secured around the rotor ring. The system may further include a battery and a control system operatively connected to the plurality of electromagnets and the battery. The control system may be configured to increase a speed of rotation of the rotor assembly, maintain the speed of rotation of the rotor, and decrease the speed of rotation of the rotor assembly. A human machine interface may be in operative communication with the control system wherein the human machine interface is configured to receive as input from an operator a revolutions per minute for operation of the power generator. The system may further include a sensor electrically connected to the control system for determining rotation rate of the rotor assembly. The human machine interface may be further configured to receive as input from an operator a torque value for the power generator. The system may further include a housing encasing the stator assembly, the rotor assembly, the battery, and the control system. The housing may include a door assembly, the door assembly hinged to an electromagnetic stator and permanent magnet drive assembly, and a control computer and start-up battery assembly hinged to the electromagnetic stator and permanent magnet drive assembly wherein the control system comprises the control computer, wherein the control computer and the battery are both housed in the control computer and start-up battery assembly. The system may further include a window in the door. The system may be a part of an electric vehicle such as a ship.

According to another aspect, an electric vehicle includes an electric power generator having a shaft, a system operatively connected to the electric power generator to rotate the shaft, the system may include an inner ring, an outer ring, a plurality of electromagnets positioned between the inner ring and the outer ring, a plurality of planar collector coils positioned around the inner ring, a battery electrically connected to the electromagnets and the plurality of planar collector coils, and a control system operatively connected to the battery and the plurality of electromagnets.

### BRIEF DESCRIPTION OF THE FIGURES

FIG. 1 is a perspective view of one embodiment of a system including an electric power generator.

FIG. 2 is a front view of the system configured for use with an electric power generator.

FIG. 3 is a side view of the system.

FIG. 4 is a perspective view of the system illustrating three assemblies which are hinged together to allow for easy access.

FIG. 5 is an exploded view further illustrating the system.

FIG. 6 is a front view of the rotor assembly.

FIG. 7 is a back view of the rotor assembly.

FIG. 8 is a back view of a rotor assembly with the cover removed and the disc not present.

FIG. 9 is a cross-sectional view of the rotor assembly.

FIG. 10 is an exploded view of the rotor assembly.

FIG. 11 is another cross-sectional view.

FIG. 12 is a front view of the stator assembly.

FIG. 13 is a side view of the stator assembly.

FIG. 14 is a perspective view of the stator assembly.

FIG. 15 is a cross-sectional view through the electromagnet at the hall effect sensor.

FIG. 16 is a front view of the control computer and start-up battery assembly.

FIG. 17 illustrates a side view of the control computer and start-up battery assembly.

FIG. 18 illustrates a perspective view of the control computer and start-up battery assembly.

FIG. 19, and FIG. 20 illustrate one example of a control methodology which may be used.

FIG. 21 illustrates one example of an initialization process.

FIG. 22, FIG. 23, and FIG. 24 further illustrate alloy casing which is used as a part of the system.

FIG. 25 illustrates one example of a ship in the form of a cargo ship.

FIG. 26 shows a compartment within the cargo ship in more detail.

FIG. 27 illustrates another example of a ship in the form of a ferry.

FIG. 28 further illustrates the compartment which includes a generator with a system.

FIG. 29 illustrates a compartment within the ship in relationship to the propulsion system.

FIG. 30 illustrates one example of a human-machine interface.

### DETAILED DESCRIPTION

Generally, methods, apparatus, and systems are provided for electric power generation. In particular, a system is provided which acts as a prime source to rotate the shaft of an electrical power generator to generate electricity. A stored energy source such as a battery may be used to provide initial power to meet startup torque requirements. The stored energy source may be used to power an array of electromagnets of a stator which are energized in a manner to move a rotor which includes permanent magnets using principles of a brushless DC motor. The rotor is attached to a shaft of the power generator. Collector coils are positioned on the stator which are connected to the stored energy source to recharge it.

A control system is provided which may include a human machine interface (HMI). The control system allows for easy initialization, control, and monitoring of the system through the HMI or remotely. Various features are provided to enhance operability and maintenance of the system these include the housing or casing which provides for separation of different assemblies.

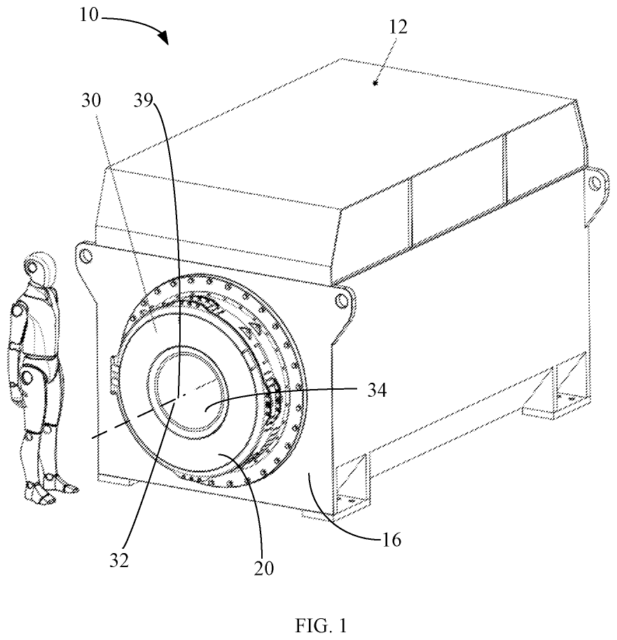

FIG. 1 illustrates a perspective view of one example of system 10 which includes a main power generator 12 such as an ABB 7 MW generator which is retrofitted with the system 20. The main power generator 12 may be a conventional power generator which includes a shaft (not shown) which is positioned along a central longitudinal axis 39. The rotor assembly of the system 20 is fit on the shaft of the device on an end 16 of the power generator 12. A door 30 with a window 32 is shown which allows for viewing of a disc of a rotor assembly of the system 20.

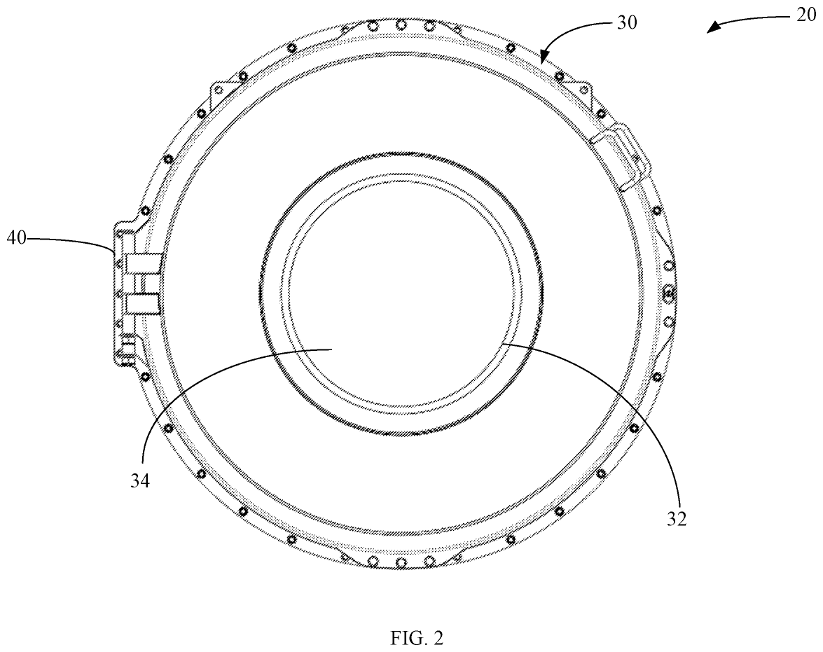

FIG. 2 is a front view of the system 20 with the door 30 with the window 32 for viewing the disc 34 of a rotor assembly of the system 20. A first hinge 40 is shown. In operation, the door 30 may be opened to provide access to other portions or layers of the system 20.

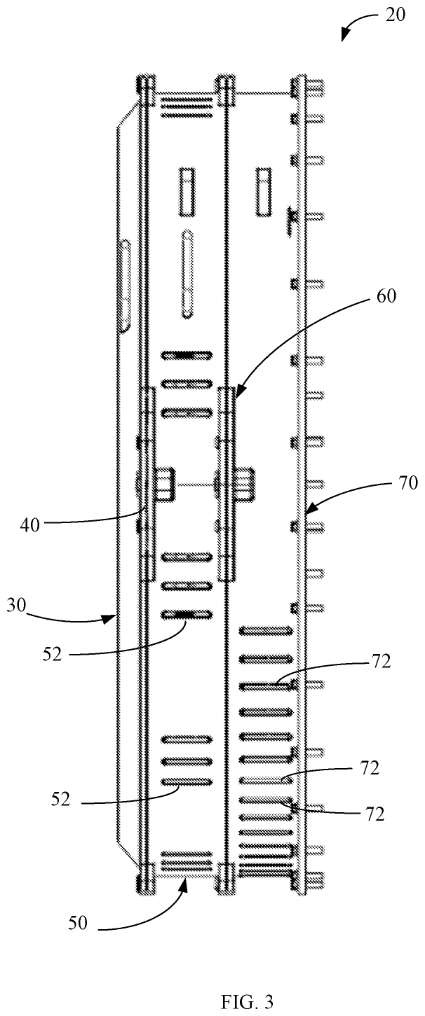

FIG. 3 is a side view of the device. The hinges are shown which includes the first hinge 40 as well as a second hinge 60. Thus, the door 30 may be opened to provide access to an electromagnetic stator and permanent magnet drive assembly 50. Or alternatively, or in addition, the second hinge 60 may be opened to provide access to a control computer and start-up battery assembly 70.

This configuration of the device is advantageous as it allows for easy access to different assemblies within the system while still allowing the system to have a relatively small profile and be convenient to retrofit existing generators.

Vent slots 52 in the electromagnetic stator and permanent magnet drive assembly 50 and vent slots 72 in the control computer and star-up battery assembly 70 are also shown which allow for air flow and cooling purposes, especially for the electromagnets.

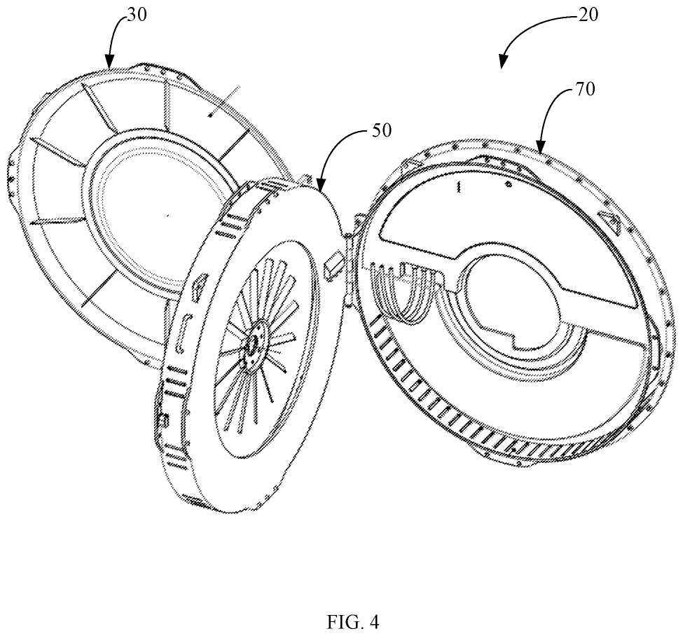

FIG. 4 is a perspective view of the system 20 showing three assemblies operatively connected together with hinges. The assemblies include the door 30, the electromagnetic stator and permanent magnet drive assembly 50, and the control computer and start-up battery assembly 70. This arrangement provides for convenient access to and service of different assemblies which can be a significant advantage to eliminate downtime in usage of the system 20.

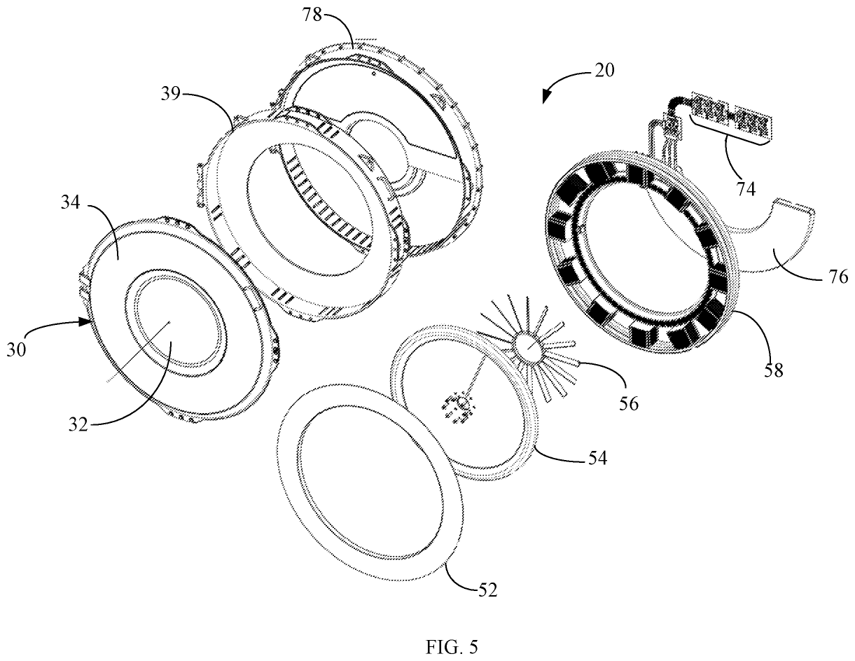

FIG. 5 is an exploded view of the system 20. The door 30 is shown which includes a see-through or transparent window 32 in a case 34. The electromagnetic stator and permanent magnet drive assembly includes a protective shroud 52 which is positioned around a rotor assembly 54. A cooling fan 56 is positioned behind the rotor assembly 54. A stator electromagnetic assembly is shown as well as a case 58 for the electromagnetic stator and permanent drive assembly. A battery 76 and control computer 74 are also shown which may be positioned within the case 78 of the control computer and start-up battery assembly.

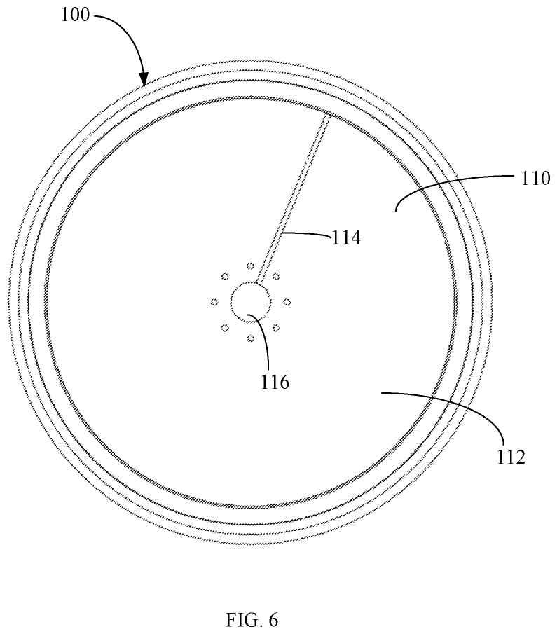

FIG. 6 is a front view of the rotor assembly 100. As shown, a rotor ring 110 is shown which extends annularly around a disc 112. The disc may be constructed from a high strength material. One example of such a material which may be used is KEVLAR (poly paraphenylene terephthalamide). Various types of different KEVLAR fibers may be used, and it is contemplated that different composites may be used which include KEVLAR fibers and other materials. An opening 116 is shown which is associated with the shaft of the main generator. A visual rotation indicator 114 is also shown. Such a marking allows for an operator observing rotation through the transparent window of the door to have a visual reference with respect to speed of rotation.

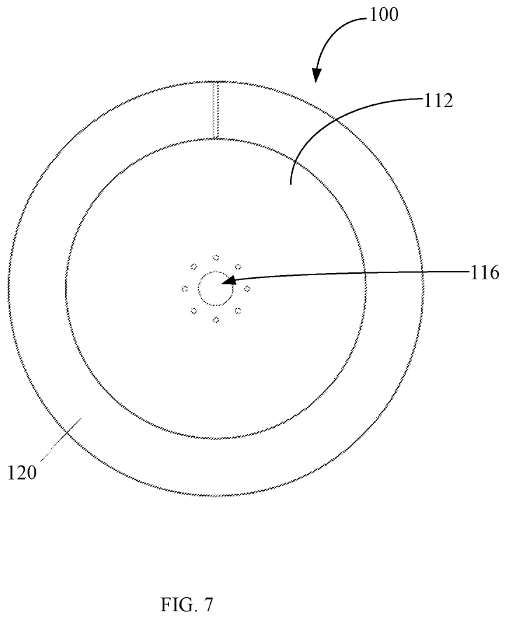

FIG. 7 is a back view of the rotor assembly 100. A cover 120 which may be formed from a plastic such as PVC (polyvinyl chloride). The cover is used to protect the permanent magnets. The disc 112 is shown as well as the opening 116 for the shaft.

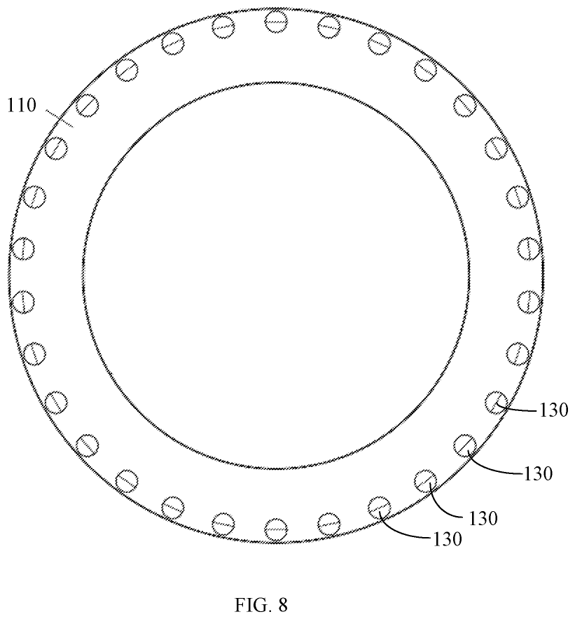

FIG. 8 is a back view of a rotor assembly with the cover removed and the disc not present. The rotor ring 110 is shown which may be formed of a non-magnetic allow material. A plurality of circular permanent magnets 130 are positioned around the periphery of the ring in a spaced apart relationship from one another. As shown, there are 30 permanent magnets encircling the ring. As shown, the north pole of the magnetics is the most inwardly positioned pole while the south pole is the most outwardly positioned pole.

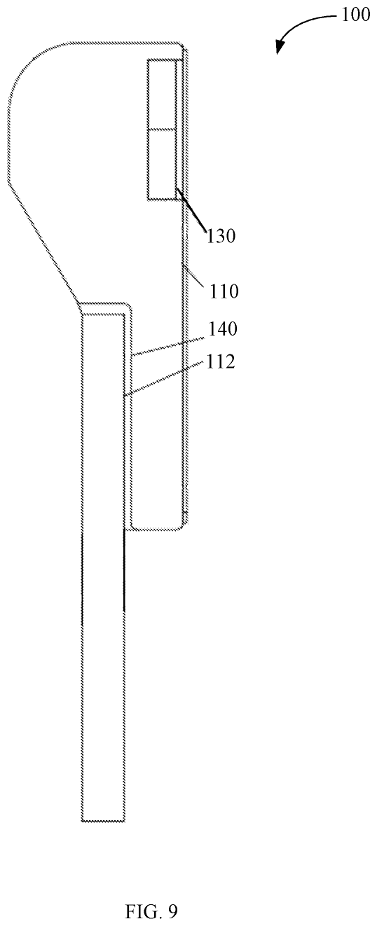

FIG. 9 is a cross-sectional view of the rotor assembly 100. An epoxy 140 may be used to bond the disc 112 to the rotor ring 110. Epoxy may also be used to bond the permanent magnet 130 to the rotor ring 110.

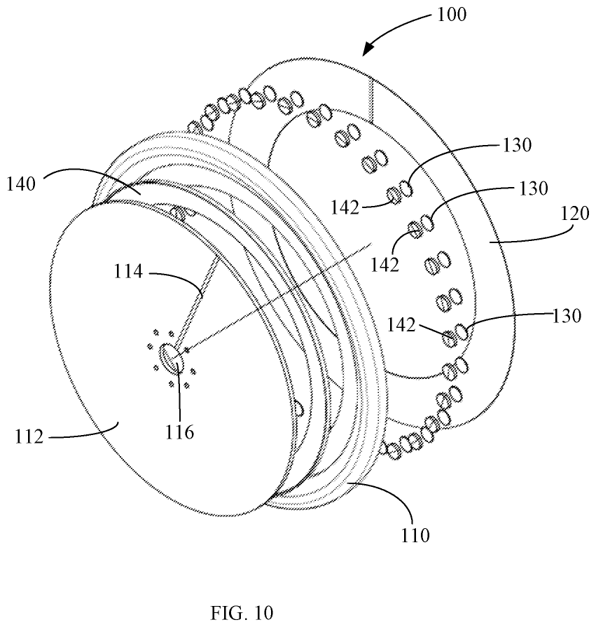

FIG. 10 is an exploded view of the rotor assembly 100. The disc 112 is shown with a central opening 116 and a visual indicator 114. The disc 112 is bonded to the rotor ring 110 with epoxy 140 or other adhesive. The permanent magnets 130 are shown arranged around the rotor ring 110 and are secured in place using epoxy 142. The cover 120 is also shown which covers the permanent magnets.

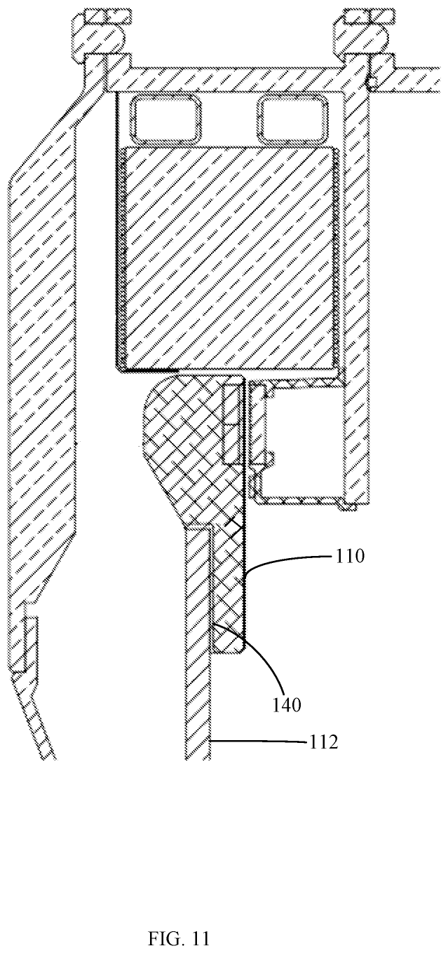

FIG. 11 is another cross-sectional view. FIG. 11 illustrates the rotor assembly in combination with the stator assembly.

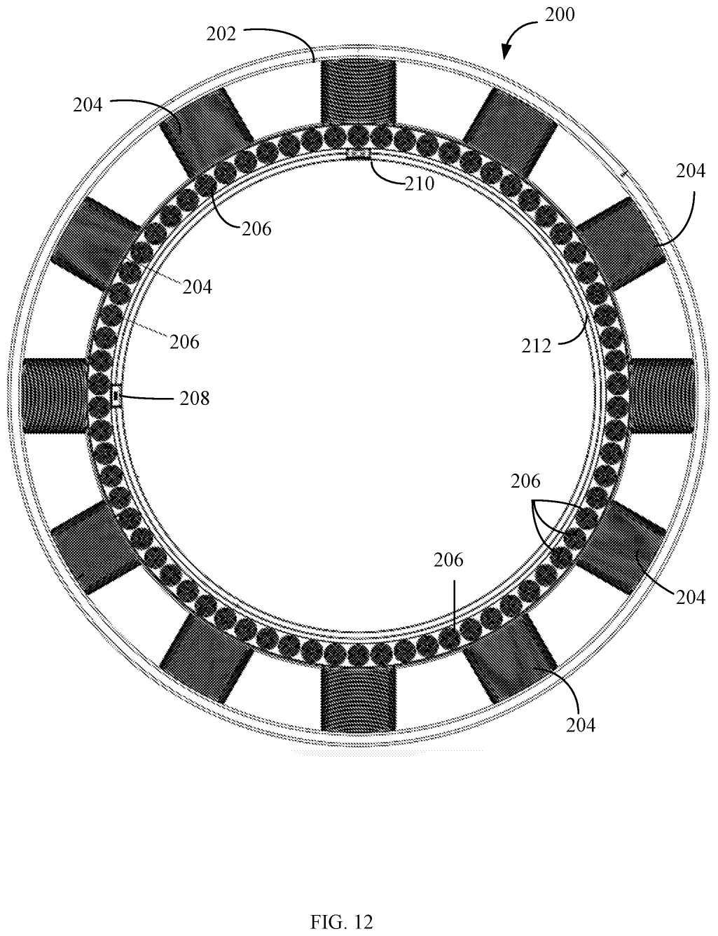

FIG. 12 is a front view of the stator assembly 200. The stator assembly 200 has a ring configuration with cable conduits 202 arranged in circular fashion at an outer periphery of the stator assembly. Only one of the cable conduits 202 is shown in FIG. 12. A bridge 212 may be positioned inside or concentric to the cable conduits 202. The bridge 212 may be formed from plastic such as ABS plastic. An electromagnetic array formed from a plurality of spaced apart electromagnets 204 positioned around the stator assembly 200 between the cable conduits 202 and the bridge 212 is shown. A collector coil array formed from a plurality of collector coils 206 positioned around the bridge 212 is also shown. It is advantageous to have the collector coils 206 positioned completely around the bridge 212 in order to collect more energy than if fewer coils were used positioned only part way around the bridge 212.

A hall effect sensor 210 is shown on the bridge 212. A photo sensor 208 is also shown on the bridge 212. The hall effect sensor 210 serves to sense position of the disc. The photo sensor 208 may be used as a part of a non-contact tachometer to detect each rotation although it is contemplated that other types of sensor systems may be used to count rotations and/or otherwise monitor position of the rotor assembly.

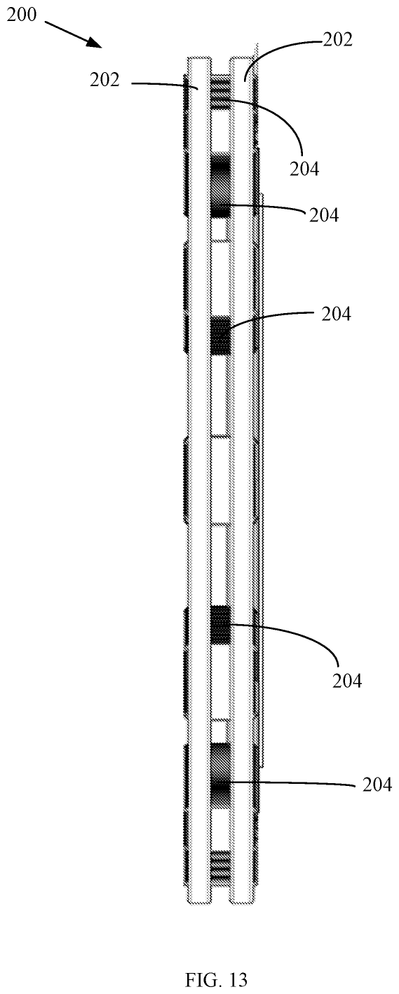

FIG. 13 is a side view of the stator assembly 200. There are conduits 202 on opposite sides. The electromagnets 204 are shown extending between the conduits 202. Wiring for the electromagnets 204 extends through the conduits 202. The conduits may be formed from PVC or other types of plastic conduit.

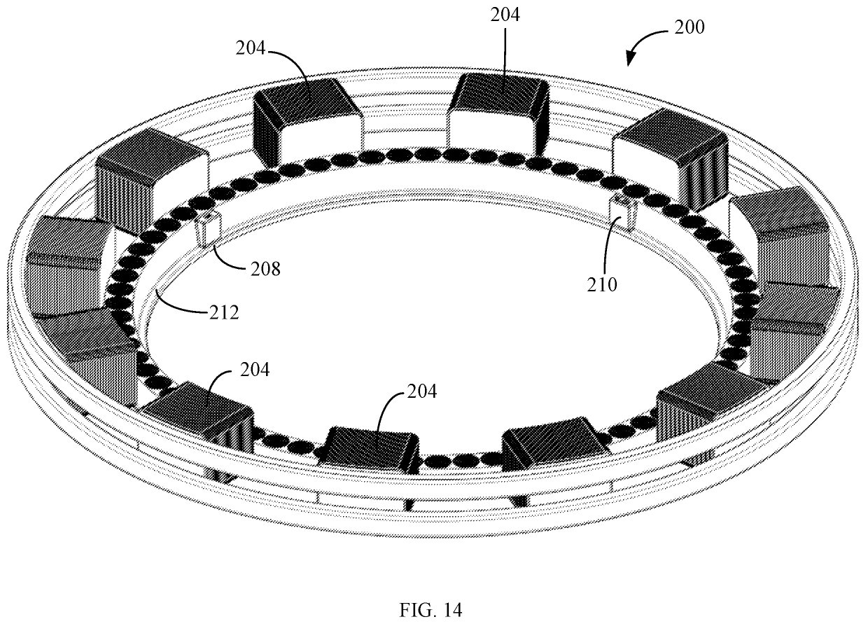

FIG. 14 is a perspective view of the stator assembly 200. As shown in FIG. 14, the electromagnets 204 are shown positioned between the conduits 202 and the bridge 212. The hall effect sensor 210 and the photo sensor 208 are also shown. The electromagnets 204 within the array are organized such that neighboring electromagnets have opposite polarities.

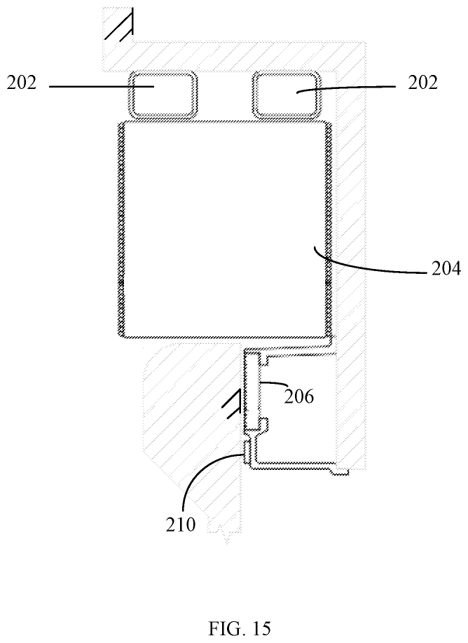

FIG. 15 is a cross-sectional view through the electromagnet at the hall effect sensor 210. The electromagnet 204 may be formed from an electromagnetic ferrite core with a plurality of copper windings.

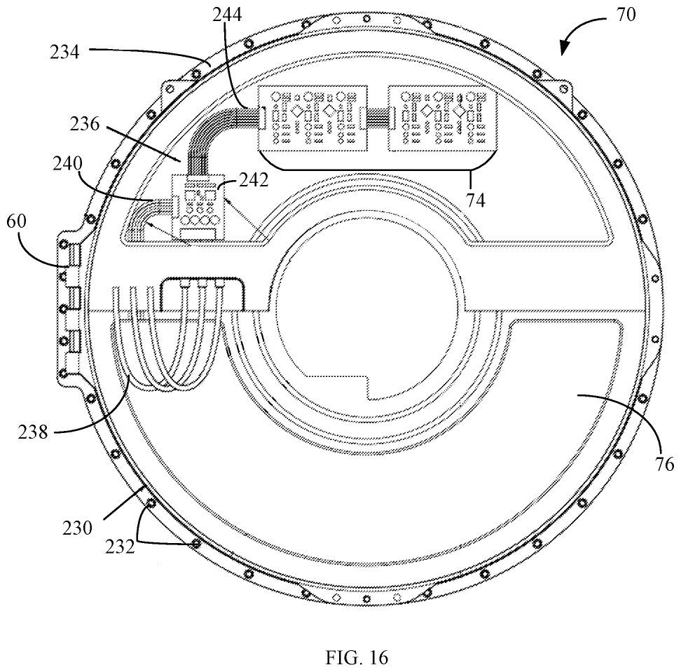

FIG. 16 is a front view of the control computer and start-up battery assembly 70. A rechargeable battery 76 is shown which may be a Li-Po (lithium polymer) or other type of rechargeable battery. A nonmagnetic alloy disc casing 234 is shown. The nonmagnetic alloy disc casing may bolt directly to the generator with bolts 232. A rubber gasket 230 is shown which may be seated at the nonmagnetic alloy disc casing 234.

A computer 74 is shown which may be electrically connected via interconnects 244 to a power module 242 which may include a power controller, a power supply, and charging circuit. The power module 242 is electrically connected through power cable 240 to the battery 76. Cables 238 are electrically connected to the EM assembly and provide for receiving data such as from the Hall sensor and photo sensor. The power module 242 and the computer 74 are positioned behind an inspection window 236 which may be transparent or semi-transparent. The inspection window 236, may be formed from a plexiglass material.

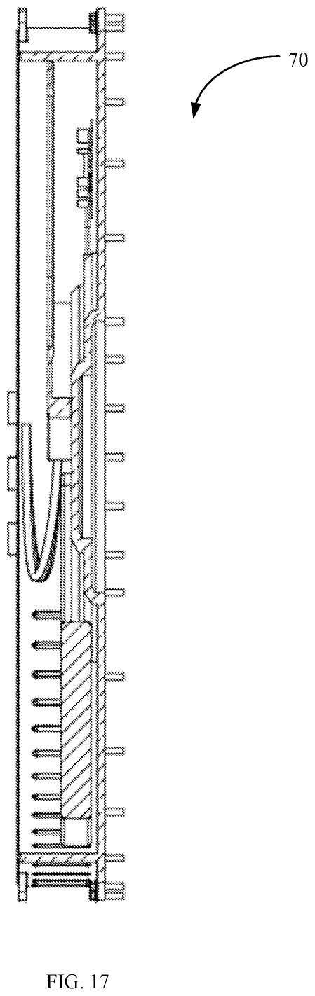

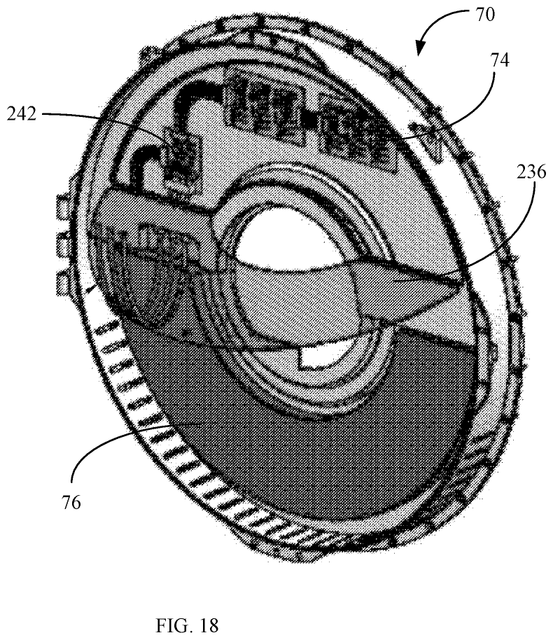

FIG. 17 illustrates a side view of the control computer and start-up battery assembly 70. FIG. 18 illustrates a perspective view of the control computer and start-up battery assembly 70. Note that in FIG. 18, the inspection window 236 functions as a door to hinge open such that the control computer and power module are readily accessible.

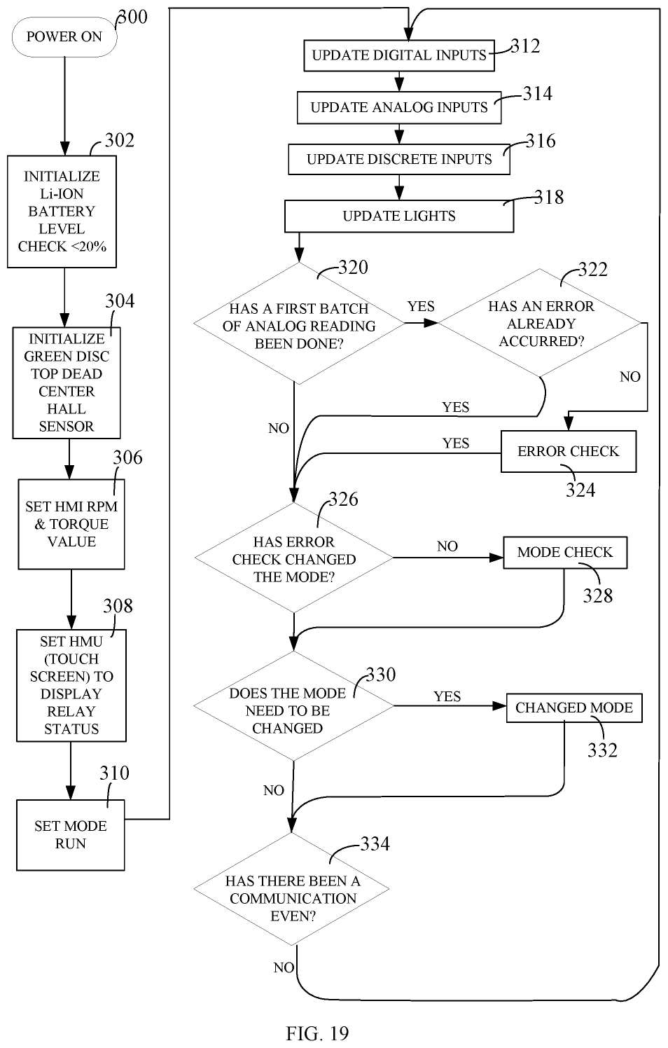

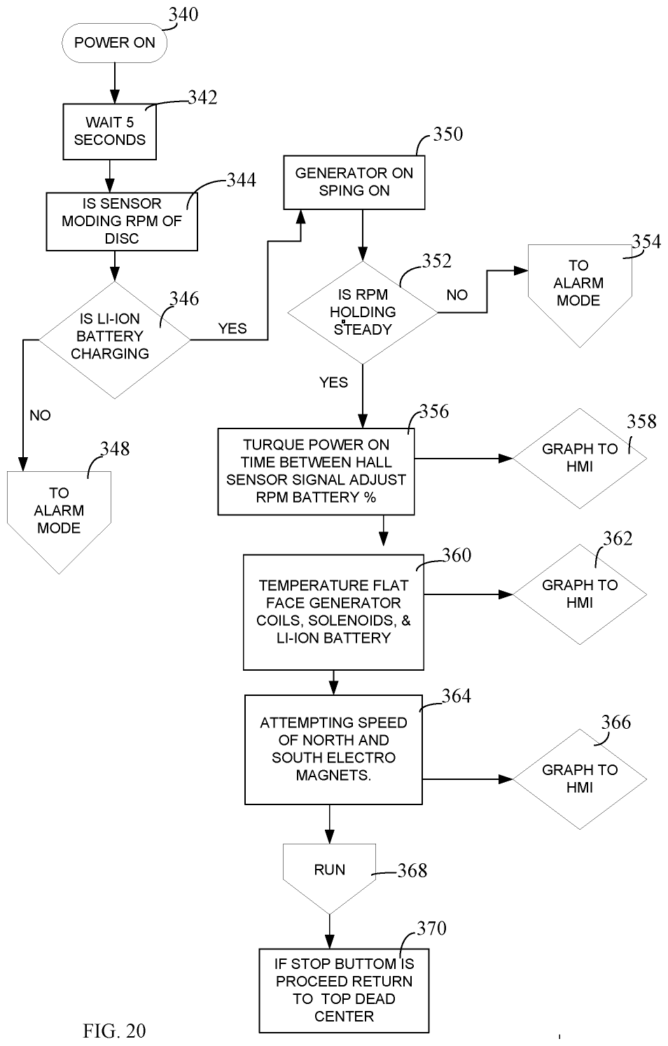

FIG. 19 through FIG. 21 illustrate one example of a control methodology which may be used. FIG. 19 illustrates a main loop defining logic flow. In step 300, power is turned on. In step 302, an initialization procedure is performed to check the rechargeable battery level. For example, if the battery level is more than 20 percent or another threshold level then the process may continue. If the battery level is less than the threshold level than the initialization process may cease to continue until the battery level is increased through charging or battery replacement.

Next in step 304, an initialization procedure is performed to move the green disc to dead center of the hall sensor. In step 306, the HMI RPM and torque value for the generator are set. In step 308, the HMI may be set to show relay status. In step 310, the mode may be set to run. In step 312, the digital inputs are updated. In step 314, the analog inputs are updated. In step 316, discrete inputs are updated. In step 318, the lights are updated. In step 320, a determination is made as to whether a first batch of analog readings has been performed. If the first batch of analog readings has been performed, then in step 322, a determination is made as to whether or not an error has occurred. If not, then in step 324, an error check procedure is performed. Returning to step 320, if a determination is made that the first batch of analog readings has not been performed then the logic flows to step 326. Returning to step 322, if a determination is made than an error has already occurred than the logic moves to step 326. In step 326, a determination is made as to whether or not the error check has changed the mode. If not, then in step 328, a mode check procedure is performed. Then the logic flows to step 330. Returning to step 326, if a determination is made that the error check changed the mode then the logic flow proceeds to step 300. In step 330, a determination is made as to whether or not the mode needs to be changed. If a determination is made that the mode needs to change, then in step 332, a change mode procedure is performed. If in step 330, a determination is made that the mode does not to be changed then the process proceeds to step 334. In step 334, a determination is made as to whether or not there has been a communication event. If a communication event has not occurred, then the process loops to step 312.

FIG. 20 further illustrates logic flow and control. In step 340, power is turned on. In step 342, the process waits for a time period such as 5 seconds. Next in step 344, the procedure waits until the sensor is reading the RPM of the disc. Next in step 346, a determination is made as to whether the rechargeable battery is charging. If it is not, then in step 348, an alarm mode is initiated. If in step 346, a determination is made that the rechargeable battery is charging, then the process continues to step 350. In step 350, a procedure is performed to turn the generator on and turn the system on. Next in step 352, a determination is made as to whether the speed (RPMs) is holding steady. If not, then in step 354, an alarm mode is initiated. If the speed is holding steady, then in step 356, torque power is turned on and the time between the Hall sensor signal adjust RPM battery percentage is communicated to provide a graph on the HMI in step 358.

In step 360 temperature for the fact, generator coils, solenoids, and rechargeable battery is collected and in step 362, communicated to provide a graph on the HMI in step 362.

In step 364, data regarding the alternating speed of north and south electromagnets is collected and communicated to provide a graph on the HMI in step 366.

In step 368, the system continues to run. In step 370, if a stop button is pressed than the rotor assembly may be returned to a top dead center position.

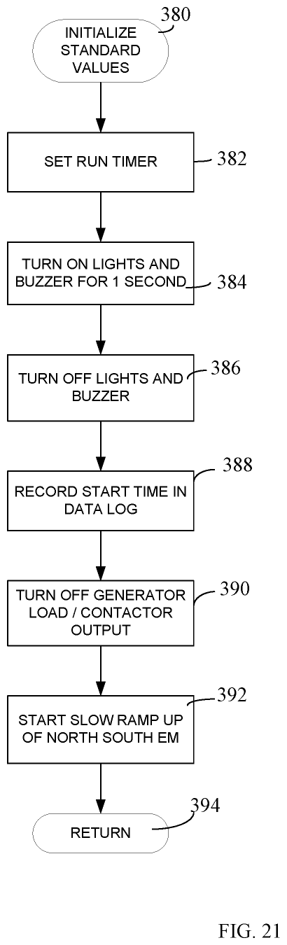

FIG. 21 illustrates one example of an initialization process. In step 380, standard values are initialized. In step 382, a run timer is set. In step 384, lights and buzzer are turned on for a short time period such as 1 second. In step 386, the lights and buzzer are turned off. In step 388, the start time is recorded in a data log. In step 390, the generator load/contactor output is turned off. In step 392, a slow ramp up of North and South electromagnets is performed. In step 394, the processor returns.

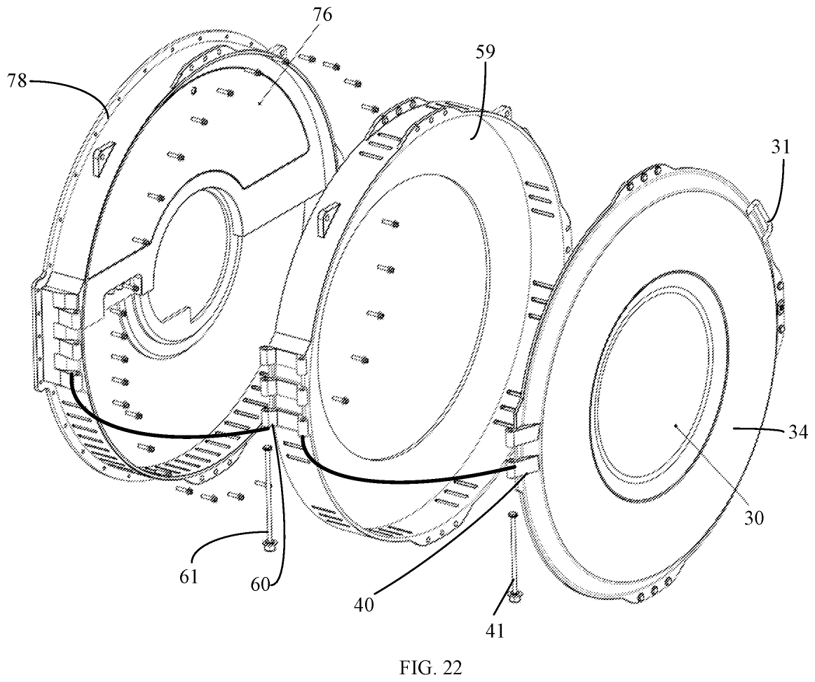

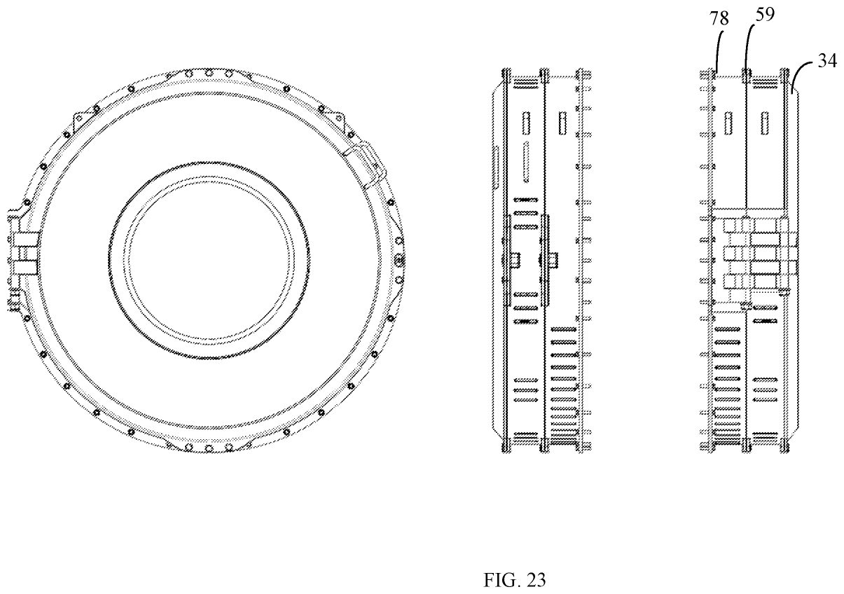

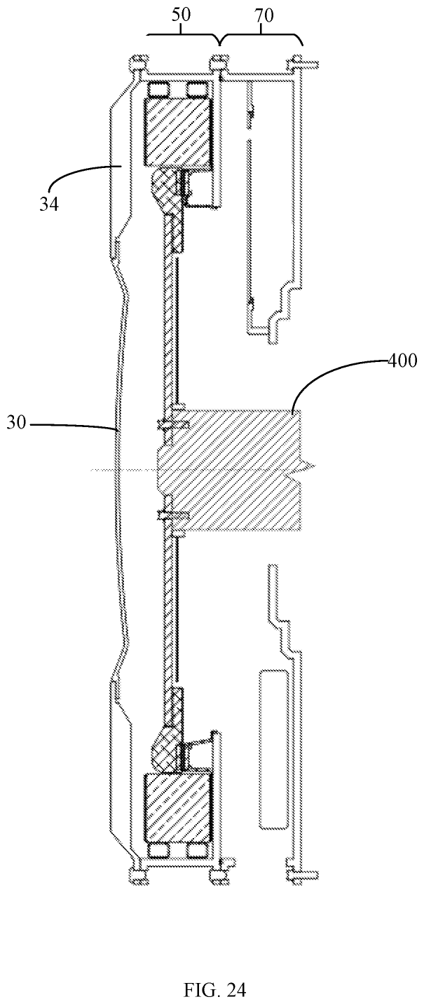

FIG. 22 through FIG. 24 further illustrates alloy casing which is used as a part of the system. As shown in FIG. 22, the housing or casing for the system has three primary components including a door 34 with a window 30. A grab handle 31 may be present on the door. The door 34 is connected with a hinge to a case 59 for the electromagnetic stator and permanent drive assembly. The hinge 40 has a hinge pin 41. The case 59 is double hinged in that both the door 34 and the case 78 of the control computer and start-up battery assembly are hinged to the case 59. A second hinge 60 has a second hinge pin 61. FIG. 23 further shows a side view of the casing when the casing is all closed. FIG. 24 illustrates a sectional view. Note in FIG. 24 that the shaft 400 of the main generator is shown which is secured to the rotor portion of the assembly 50.

In operation, the system uses a principle of combined physics laws of rotational kinetic energy, angular momentum, work, inertia, induction, and Eddy currents. Rotational kinetic energy is used as the rotor assembly is installed on the same axis as the rotor of the main electric power generator. The mass of the rotor of the main power generator has greater mass (inertia) and thus generates more kinetic energy that the rotor assembly uses to charge its own battery system.

Angular momentum is used. Although it is not a pure angular momentum as there is still an axis torque force that diminishes as the rotor RPM number increases. The RPM specified by the electric power generator's manufacturer may be obtained, which for purposes of easier understanding may be considered the angular momentum. In this way, the rotational kinetic energy is preserved at a very low electric input from the system, but at a high RPM for its own generator, thus recharging its battery system.

Inertia is used. The main electric power generator's mass and inertia is used to convert its starting torque power. Induction is also used. Between the disc and coils mounted on the stator induction is used to feed as DC voltage the rectifier, supercapacitor, and the rechargeable battery for further use of the electromagnets. Eddy currents are also used. The electromagnets receive electric impulses from the rechargeable battery and produce Eddy current (repelling of the permanent magnets), thus creating the rotation motion of the system and the axis of the main power generator.

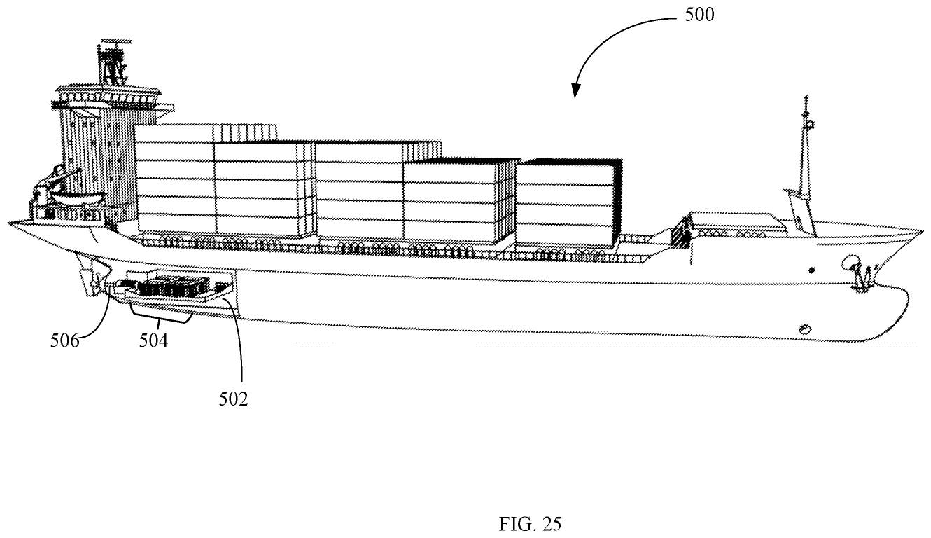

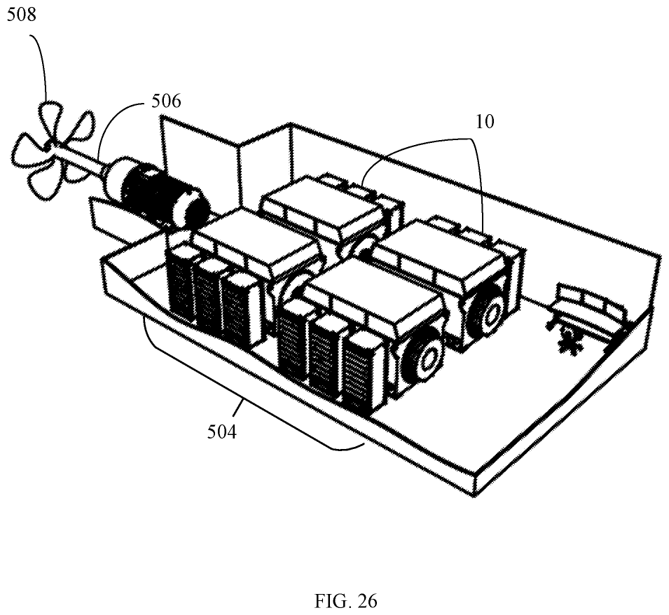

The system may be used in a number of different configurations including as a part of a power plant. Another application for the system described herein is for a vehicle such as a maritime vehicle such as a ship. FIG. 25 illustrates one example of a ship in the form of a cargo ship 500. A panel of the ship is removed to show a compartment containing a plurality of generators each with the system shown and described. Here, the shaft 506 is being driven is associated with a propulsion system of the ship such as a propeller. FIG. 26 shows the compartment in more detail. The power plant 504 for the ship may contain a plurality of generators 10 each having the system to drive a shaft 506 with an attached propellor 508.

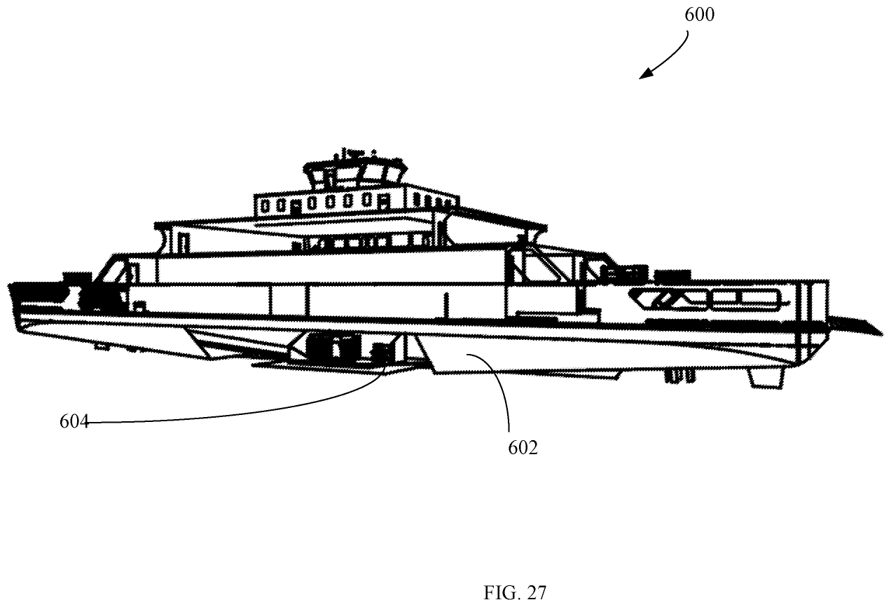

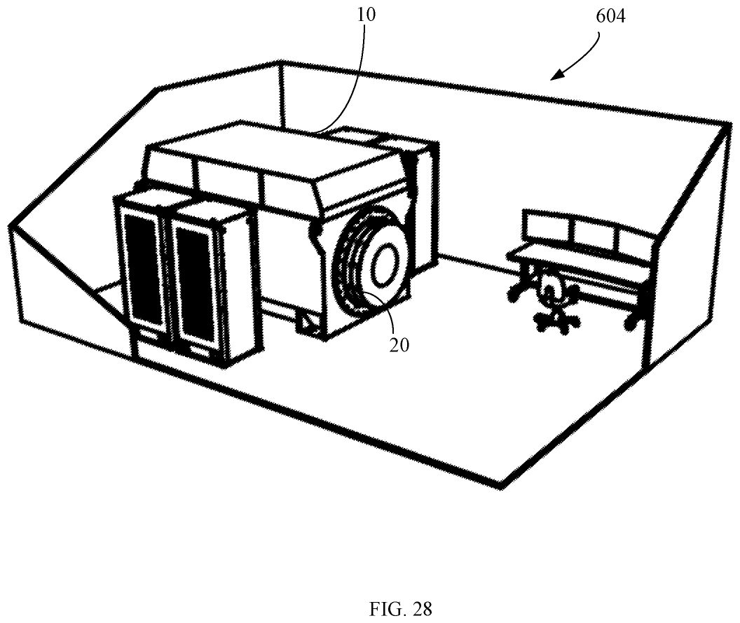

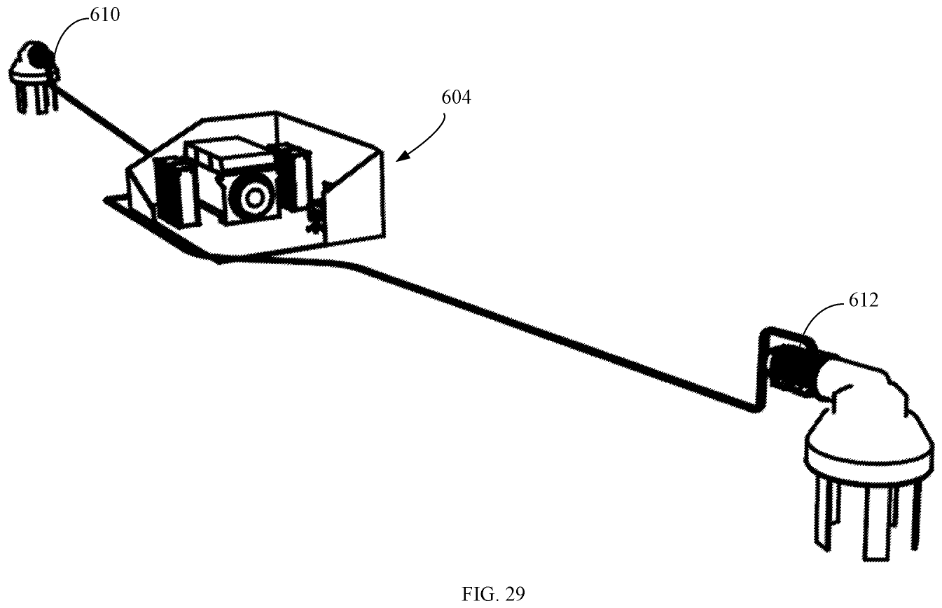

FIG. 27 illustrates another example of a ship in the form of a ferry 600. A compartment 604 is shown within the hull 602 of the ship. FIG. 28 further illustrates the compartment 604 which includes a generator 10 with a system 20. FIG. 29 illustrates the compartment 604 in relationship to the propulsion system which may include propulsion systems with electric motors 610, 612 on opposite sides of the ship to drive propellors.

Although specific examples of electric vehicles in the form of electric ships are shown, it is to be understood that the present invention contemplates that the present invention may be used in any number of different applications where electric generators are used such as to power homes, businesses, other types of electric vehicles including other types of ships, boats, submarines, water vehicles or vessels, cars, trucks, motorcycles, bicycles, agricultural vehicles, construction vehicles, military vehicles, recreational vehicles, emergency vehicles, specialty vehicles, rail-based vehicles, air vehicles, airplanes, helicopters, and others. Where used in other applications, the scale of the system may be appropriately increased or reduced based in part on the size of the vehicle, the size of the generators, the battery requirements, and other requirements.

As previously explained, a human-machine interface (HMI) may be used on the system. This may be in the form of a screen display or tablet. In configuring the system, input to the system may include a starting torque. Generally, the starting torque is what is required to move and overcome the static inertial of the machine. A further input to the system may be the maximum recommended speed of the main electric power generator. These inputs may be provided directly by a user entering these values. These inputs may be provided by having a user identify the particular main electric power generator and having a lookup table or other means to, for example, associate the particular manufacturer and model number with these parameters. It is to be understood that knowing the starting torque allows the system to determine whether current battery levels will be sufficient to start-the system. If the available battery capacity is insufficient to meet the starting torque requirements, then the system indicate to the operator that the current battery charge is insufficient and not allow the process to continue unless and until additional power requirements are met.

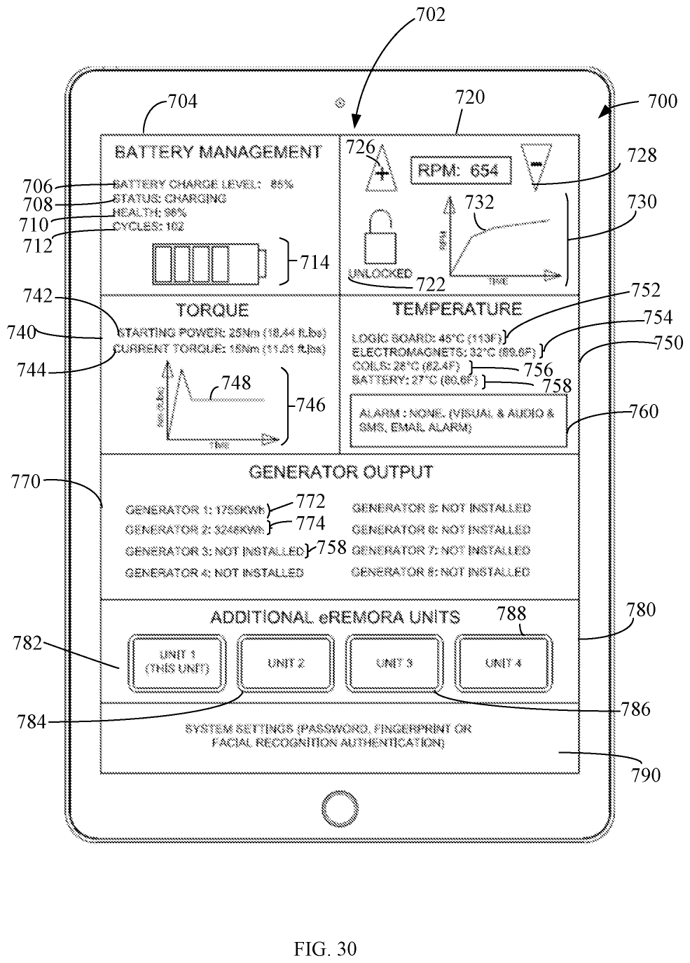

FIG. 30 shows a human-machine interface in the form of a tablet computing device 700. Although a tablet computing device 700 is shown, other types of computing devices may be used as may be appropriate or desirable in a particular implementation. In some embodiments, the tablet computing device 700 may be secured to the system, integrated into the system, or otherwise provided. Where the computing device is a tablet computing device input may be provided through a touch screen display although other types of input are contemplated including other types of manual inputs such as keyboards, mice, trackballs, buttons, dials, and other alternatives. In addition, input may be provided through voice input or other types of input.

In FIG. 30, a screen display 702 is shown. The screen display 702 may be displayed on a tablet with a touch screen display. A number of different panels 704, 720, 740, 750, 770, 780, and 790 are shown as a convenient method to convey information and/or otherwise interact with the user. A battery management panel 704 is shown. The battery management panel 704 may include information such as battery charge level 706, status information 708 for the battery such as whether or not the battery is charging or not. The information may also include the health 710 of the battery. The health may be the maximum battery capacity relative to when the battery was new. The health may be the ability for the battery deliver maximum instantaneous performance or peak power. The health may be a combination of these and/or other measures of battery health. The battery management panel 704 may further include cycles 712. The cycles may be the number of charges and discharges that the battery has incurred over its life. Information in the battery management panel 704 may be conveyed in different ways including textually, graphically or otherwise. For example, an illustration for battery charge level 714 is shown so that an operator can quickly see the battery charge level visually.

The panel 720 may provide for the display of information related to rotation for the system. This may include indicating whether or not the system is locked or unlocked 722. This may be displayed textually and/or graphically. For example, an icon showing a padlock in a locked or unlocked position may be used in addition to textual information. In a locked mode of operation, the panel 720 may indicate the rate of rotation such as the number of revolutions per minute (RPM) of the shaft. In an unlocked mode of operation, the panel may allow an operator to set the rate of rotation such as according to manufacturer specifications. The panel 720 may also provide for touch screen input areas so that the user can select to increase 726 or decrease 728 the rate of rotation. In addition, a graph 730 may be shown which may indicate the rate of rotation over time as shown with line 732. As shown, the rate of rotation begins with no rotation, ramps upwardly at a high rate, and then ramps upwardly at a slower rate.

The panel 740 provides for display of torque related information. Examples of such information includes starting power 742 and current torque 744. A graph 746 has a line 748 showing the torque over time. Note that the torque increases at starting and then decreases and remains generally constant which is what would be expected in typical operation.

The panel 750 provides for display of temperature information. This may include temperatures for different components within the system, especially those components which may be most subject to over-heating or whose performance may be negatively impacted by temperature. Examples may include logic board temperature 752, electromagnet temperature 754, coil temperature 756, and battery temperature 758. It is contemplated that a number of temperature sensors may be used at different locations. For example, there may be a temperature sensor associated with each electromagnet. Where this is the case, the panel 750 may display the temperature for each electromagnet. Alternatively, the panel may display the temperature for the electromagnet with the highest temperature and also may provide the option of seeing temperature data in more detail including for each temperature sensor. Related alarms associated with temperature may also be shown. Alarms may be provided in different manners including visual alarms, audio alarms, SMS alarms, email alarms, or other types of alarms to notify operators or others in case operating conditions reach a threshold associated with the alarm. A user may select the alarm button 760 in order to configure alarms. Configuring an alarm may entail identifying which type of alarms are desired, thresholds for the alarms, and/or other information used to generate and communicate one or more alarms to the operator or other individuals.

The panel 770 provides for displaying generator output. It is contemplated that a single user interface may be used to monitor and control multiple systems, each of the systems associated with a generator. The generator output for each of these generators may be displayed. The output for the first generator 772 is shown and the output for the second generator 774 is shown. If a third or subsequent generator which can be accommodated but is not present, then the interface may indicate the generator as being not installed 758.

The panel 780 allows for selection by a user of a different unit. As shown, there is a button 782 for the first unit, in this instance the unit for which information is displayed. There is a button 784 for a second unit, a button 786 for a third unit, and a button 788 for a fourth unit. An operator may select which unit to display information about at any time.

A panel 790 is also shown which a user may use to modify system settings such as authentication methods which may, for example, be password, fingerprint, or facial recognition authentication. The system settings may include any number of other settings which are used to describe or identify characteristics of the system, the operator, or other settings.

That which has been shown in FIG. 30 is merely representative and any number of types of human-machine interfaces are contemplated. It should be apparent that in different environments and different contexts that different types of human-machine interfaces may be provided whether presented using one or more displays, audio, or other types of systems for interaction with a user. The human-machine interface shown allows an operator to visually monitor important status information for one or more systems and control aspects of the one or more systems. Depending upon the specific application and environment either more or less information may be displayed or otherwise presented to an operator. This is performed in an easy to use and intuitive manner.

For example in operation, an operator may press the icon indicating locked or unlocked 722 in order to unlock the functionality to set the rotation rate for the generator, assuming the system is unlocked and, if required, the user has already been granted access to the system such as by providing a password, biometric authentication, multi-factor authentication. The operator may then press the up 726 and down 728 buttons on the screen display until the RPM recommended by the main electric power generator is reached. A non-contact tachometer may be used to monitor speed of the rotor assembly. The measured RPMs may be communicated to an RPM fan speed control unit which activates each of the electromagnets in push and pull position (where 12 are present, 6 would be in a push position and 6 would be in a pull position) for the brushless DC monitor. A Hall effect sensor is positioned before one of the electromagnets and may be used to trigger the control of the electromagnets. Once the desired speed is reached, the operator may then press the icon indicating locked or unlocked 722.

In order to stop operation of the system, the user may press the icon to unlock 722 the system. The user may then set the RPM to 0 or, if present, select a stop button. The electromagnets may be arranged in one circuit controlled by the fan speed control unit. Where 12 electromagnets are present, 6 may be of a first polarity (N−) and six may be of an opposite polarity (P+). When in a stop mode of operation, the electromagnets of the first polarity (N−) may switch the current flow to become the second polarity (P+) so that all of the electromagnets are of the second polarity. This will result in a full stop of the rotor assembly. Once a full stop is reached, the operator may select to lock the rotor assembly controls by selecting the lock/unlock icon 722.

In some embodiments, the electromagnets may be DC electromagnets, but alternatively may be AC electromagnets. Where AC electromagnets are used a rectifier may be used as DC volage is supplied from the batteries. The control system may be configured with a hardware switch so that that the same system can be configured with either DC or AC electromagnets.

As shown and as described it is to be understood that multiple systems may be present in a single installation, such as a power generation plant or an electric ship having multiple systems. Where multiple systems are used, an operator may monitor the multiple systems. It is further contemplated that monitoring and control may also be provided from a remote location. In such embodiments, control system may be operatively connected to a network such as a Wi-Fi network, satellite network, or other type of network and be configured for communications over the network. There are various situations where this may be implemented. For example, where there is a fleet of vehicles, a single command or dispatch location may be tasked with monitoring and controlling multiple vehicles. Data from the control system may be combined with other data including other sensor data, location data, imagery data to assist the command or dispatch locations understand local operation and make informed decisions if required.

Thus, various methods, and apparatus have been shown and described. It is to be understood that numerous embodiments, options, variations, and alternatives are contemplated based on the particular application and attendant requirements. The present invention is not to be limited to the specific embodiments shown and described herein.

1. An apparatus for rotating a shaft, the apparatus comprising:
an inner ring;
an outer ring;
a plurality of electromagnets positioned between the inner ring and the outer ring;
a plurality of planar collector coils positioned around the inner ring;
a battery electrically connected to the plurality of electromagnets and to the planar collector coils;
a control system operatively connected to the battery and the plurality of electromagnets.

2. The apparatus of claim 1 further comprising a disc secured to the inner ring.

3. The apparatus of claim 2 further comprising a human machine interface in operative communication with the control system wherein the human machine interface is configured to receive as input from an operator a revolutions per minute for operation of a power generator.

4. The apparatus of claim 3 wherein the human machine interface is further configured to receive as input from an operator a torque value for the power generator.

5. The apparatus of claim 1 further comprising a housing comprising a first assembly, a second assembly, and third assembly and wherein the first assembly is hinged to the second assembly, and the third assembly is hinged to the second assembly.

6. The apparatus of claim 5 wherein the first assembly comprises a door with a window.

7. The apparatus of claim 6 wherein the second assembly comprises the inner ring, the outer ring, the plurality of electromagnets, and the plurality of planar connector coils.

8. The apparatus of claim 7 wherein the third assembly comprises the battery and a computer associated with the control system.

9. The apparatus of claim 8 further comprising a human machine interface in operative communication with the control system.

10. A vehicle comprising the apparatus of claim 1 and wherein the shaft is configured to assist in generating movement for the vehicle.

11. The vehicle of claim 10 wherein the vehicle is a ship.

12. The apparatus of claim 3 wherein the control system receives as input a torque value for the power generator.

13. A system configured for managing rotation of a shaft associated with a power generator, the system comprising:
a stator assembly, the stator assembly comprising:
an inner ring,
an outer ring,
a plurality of electromagnets positioned between the inner ring and the outer ring, and
a plurality of planar collector coils positioned on a face of the inner ring;
a rotor assembly, the rotor assembly comprising:
a disc,
a rotor ring secured to the disc, and
a plurality of permanent magnets secured around the rotor ring;
a battery;
a control system operatively connected to the plurality of electromagnets and the battery and wherein the control system is configured to increase a speed of rotation of the rotor assembly, maintain the speed of rotation of the rotor, and decrease the speed of rotation of the rotor assembly;
a human machine interface in operative communication with the control system wherein the human machine interface is configured to receive as input from an operator a revolutions per minute for operation of the power generator.

14. The system of claim 13 further comprising a sensor electrically connected to the control system for determining rotation rate of the rotor assembly.

15. The system of claim 13 wherein the human machine interface is further configured to receive as input from an operator a torque value for the power generator.

16. The system of claim 13 wherein the control system receives as input a torque value.

17. The system of claim 13 further comprising a housing encasing the stator assembly, the rotor assembly, the battery, and the control system.

18. The system of claim 17 wherein the housing comprises a door assembly, the door assembly hinged to an electromagnetic stator and permanent magnet drive assembly, and a control computer and start-up battery assembly hinged to the electromagnetic stator and permanent magnet drive assembly wherein the control system comprises the control computer, wherein the control computer and the battery are both housed in the control computer and start-up battery assembly.

19. The system of claim 18 further comprising a window in the door.

20. An electric vehicle comprising the system of claim 13.

21. The electric vehicle of claim 20 wherein the electric vehicle is a ship.

22. An electric vehicle comprising:
a vehicle body;
an electric power generator having a shaft;
a system operatively connected to the electric power generator to rotate the shaft, the system comprising:
an inner ring;
an outer ring:
a plurality of electromagnets positioned between the inner ring and the outer ring;
a plurality of planar collector coils positioned around the inner ring;
a battery electrically connected to the plurality of planar coils;
a control system operatively connected to the battery and the plurality of electromagnets.

23. The electric vehicle of claim 22 wherein the control system is configured to receive as input a torque value for the electric power generator.
